(19) United States
(12) Patent Application Publication
(10) Pub. No.: US 2023/0005125 A1
(43) Pub. Date: Jan. 5, 2023

(54) INTELLIGENT SYSTEM BASED ON COMPUTER VISION FOR WIRE INSTALLATION QUALITY ASSESSMENT

(71) Applicant: AT&T Intellectual Property I, L.P., Atlanta, GA (US)

(72) Inventors: Ni An, Plano, TX (US); Michael Charo, Frisco, TX (US); Hector Tejada, The Colony, TX (US); Kaijuan Xing, Plano, TX (US); Emily Williams, Richardson, TX (US); Prateek Baranwal, Dallas, TX (US)

(73) Assignee: AT&T Intellectual Property I, L.P., Atlanta, GA (US)

(21) Appl. No.: 17/363,352

(22) Filed: Jun. 30, 2021

(51) Int. Cl. G06T 7/00; G06K 9/00; G06K 9/32

(52) U.S. Cl. CPC G06T 7/0004; G06K 9/00671; G06K 9/3241; H02G 1/06

(57) ABSTRACT

A computer vision-based system may assist in wire installation. The system may use computer vision techniques to assess the quality of service wire installations. The system may generate text descriptions of the image of service installation work, assessing the quality of the work to facilitate searching and summarization.

### BACKGROUND

During a buried service wire (BSW) installation, a supervising technician may need to be called out to a site to review a junior technician's work. This quality check may occur in multiple different ways. In a first scenario two technicians may be sent for a service installation in which only one is required. In a second scenario, there may be a subsequent visit by a supervising technician because of complaints by a customer or proactive and periodic quality checks.

This background information is provided to reveal information believed by the applicant to be of possible relevance. No admission is necessarily intended, nor should be construed, that any of the preceding information constitutes prior art.

### SUMMARY

Disclosed herein is an advanced computer vision (CV) assisted service installation quality assessment system. The system may use computer vision techniques to assess the quality of service wire installations, for example. The system may generate text descriptions of the image of service installation work, assessing the quality of the work to facilitate searching and summarization.

In an example, a device may include a processor and a memory coupled with the processor that effectuates operations. The operations may include receiving an image; receiving an indication of a type of service installation associated with the image; determining objects of interest in the image associated with the type of service installation; determining whether the objects of interest in the image meet a minimum threshold for the type of service; and communicating acceptance or rejection of the image for a work quality assessment.

In an example, a device may include a processor and a memory coupled with the processor that effectuates operations. The operations may include in response to acceptance of the image, extracting a feature map of the image; generating a text description of work quality based on the feature map; determining a work quality score based on the text description; and communicating the work quality score to a display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1 illustrates an exemplary system for intelligent CV assisted installation.

FIG. 2 illustrates an exemplary method for intelligent CV assisted installation.

FIG. 3A illustrates exemplary system flow.

FIG. 3B illustrates an exemplary method associated with the system of FIG. 3A.

FIG. 4 illustrates a schematic of an exemplary network device.

FIG. 5 illustrates an exemplary communication system that provides wireless telecommunication services over wireless communication networks.

### DETAILED DESCRIPTION

As disclosed herein, a computer vision (CV) based system may use computer vision techniques to assess the quality of service for utility service installations. The system may generate text descriptions of the image of service installation work assessing the quality of the work to facilitate searching and summarization. Although service installation is referred to herein, it is contemplated that the CV system may be used for deactivation, repair, or the like services. Utility services may include telecommunication services, electrical services, sewer services, gas services, or other infrastructure services.

One approach to address a technician's work quality is to ask the technician to take a photo of the finished work (e.g., for buried service wire (BSW) installation, a photo showing the drop wire's connection to the fiber distribution pedestal) so that a manger can review the photo, and coach the technician on work quality issues (also referred herein as job quality). However, just using BSW as an example, there are approximately 1 million of BSW jobs completed by single service provider per year and for each BSW job it requires at least 3 photos taken for assessing the job quality (e.g., one photo showing drop wire's connection with the service terminal, one photo showing the drop wire connection with customer demarcation point, or one photo showing the drop wire path). Humans reviewing the photos may be costly and time-consuming assuming at least 3 million photos generated annually for this example scenario.

The disclosed CV system may help provide a more efficient work quality assessment. Some examples of the work quality issues for assessing a BSW installation may include: i) was the drop wire dug into the ground; ii) was the drop wire dug-in location within a reasonable distance from the service terminal/customer premises; iii) was there an appropriate amount of slack in the drop wire; or iv) was the appropriate amount of materials and debris removed from the work area, among other things.

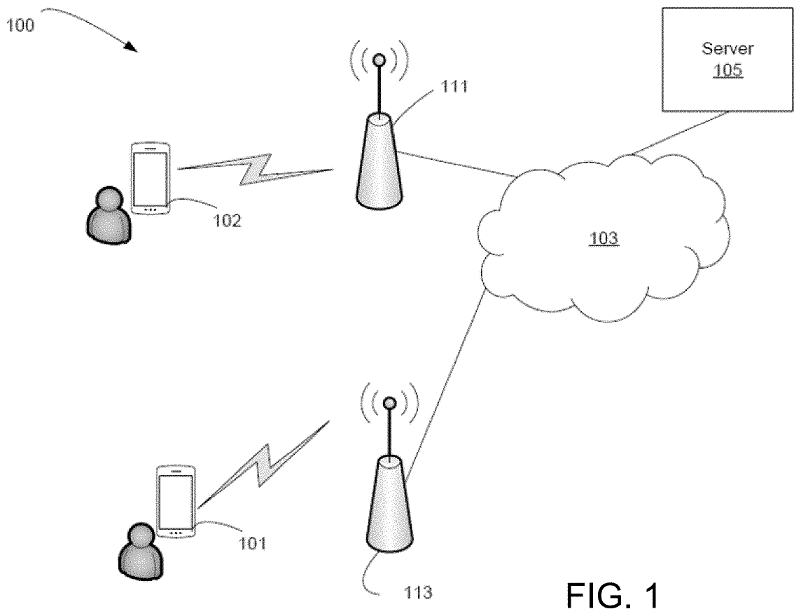

FIG. 1 illustrates an exemplary system for intelligent CV installation. System 100 may include network 103. Mobile device 101, mobile device 102, base station 111, base station 113, or server 105 may be communicatively connected with each other via network 103. Network 103 may include vRouters, access points, DNS servers, firewalls, or the like virtual or physical entities. Mobile device 101 or mobile device 102 may be able to communicate to network 103 through a wired or wireless connection.

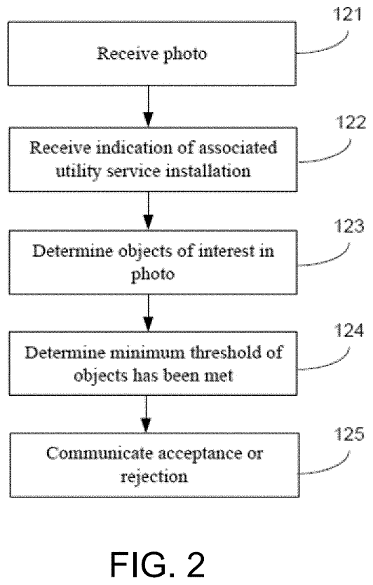

FIG. 2 illustrates an exemplary method for intelligent CV installation. In FIG. 2, the method provides for image eligibility assessment. At step 121, an image may be received. In an example, image captured by device 101 (e.g., a photo) may be transmitted to server 105 for additional processing or processed locally on device 101. At step 122, an indication of an associated service installation may be received. This may be received in a message with the image of step 121 or separately. A service installation may be a particular wiring installation for a telecommunication service or other service (e.g., electrical), installation of a heating and air service, an installation of a natural gas service, or installation of sewer service, among other things.

With continued reference to FIG. 2, at step 123, objects of interest in the image of step 121 may be determined, which may be based on the indication of associated service of step 122. As can be envisioned, an image may include several different objects, such as grass, rocks, wires of different colors, corner of a home, or different types of utility boxes, among other things. All or some of those objects may be of interest based on the indication of the associated service.

In addition, at step 124, based on step 123, after determining which objects are of interest then there is a determination of a threshold number (e.g., min or max) and type of objects that need to be shown in order to assess work quality. In an example, there may be a number of objects that should be shown for a utility wiring service, such as all of the following objects: the drop wire, the service terminal, the optical network terminal (ONT) box, the drop guard, the customer premises, etc.

At step 125, a message may be sent to communicate the acceptance or rejection of the image of step 121 based on the determination in step 124. If not enough (or too many) objects of interest are shown, then system may send a rejection alert to a device of a technician at the location (e.g., device 101) or any nearby devices to the location of the service (e.g., device 102). If the number and type of objects meet the threshold number, then an acceptance alert may be sent to device 101 of a technician of the location or any nearby devices to the location of the service (e.g., device 102).

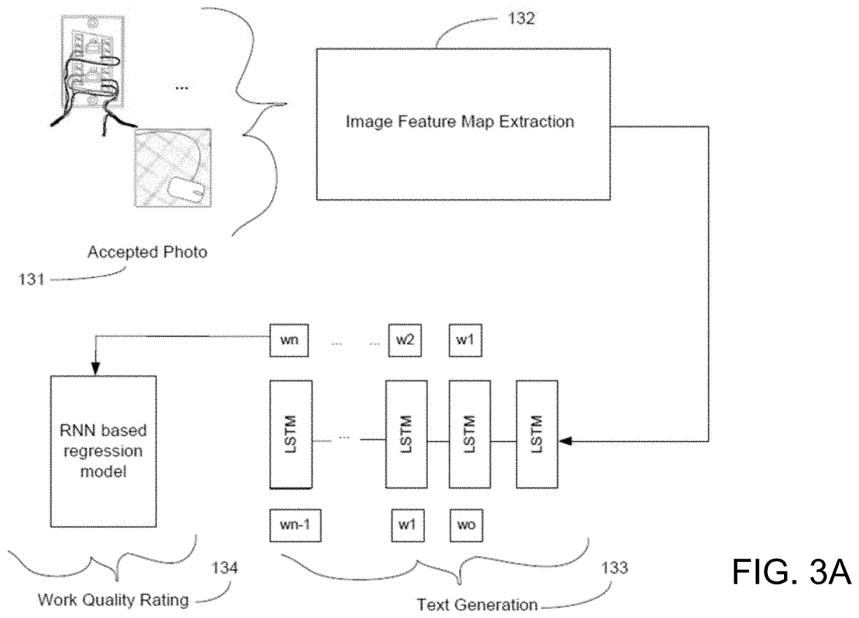

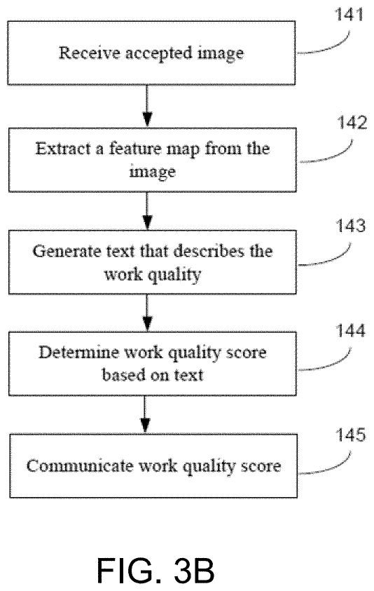

FIG. 3A-FIG. 3B illustrate exemplary methods and systems for intelligent CV assisted installation. FIG. 3A illustrates exemplary system flow. As shown, image 131 which was accepted in the method of FIG. 2, is submitted into an image feature map extraction model 132. The output of model 132 (e.g., a feature map from the image) is provided to text generation model 133. The output of model 133 (e.g., text that describes the work quality) may be provided to work quality rating model 134, which may output a work quality score. The disclosed method may occur on one device or be distributed over multiple devices.

FIG. 3B illustrates an exemplary method associated with the system of FIG. 3A. At step 141, the accepted image 131 may be received by image feature map extraction model 132. At step 142, a feature map may be extracted from image 131. Image feature map extraction model 132 may be based on a neural network, such as a convolutional neural network (CNN). At step 143, text generation model 133 may receive the feature map and generate a text that describes the work quality associated with the image. Text generation model 133 may use a neural network (e.g., recurrent neural network—RNN), an attention model, or the like to generate the text that describes the work quality. For example, text may include “the drop wire was not dug into the ground”, “there are obstacles blocking the path of the drop wire”, “drop wire is too close to the terminal”, etc. Feature map is the output of a convolution neural network layer and is a matrix/vector of numbers that is used to represent the characteristics of an image. CNN is used to extract feature map of the input image and uses the feature map as input to feed into the RNN network to predict the sequence of words that can describe the image. There may be two RNNs: i) the “LSTM”/“Text generation model” is one RNN used to generate text from CNN feature maps of the image (note that LSTM is a specific type of RNN); and ii) the RNN based regression model is another RNN that may be used to generate work quality score (e.g., a numerical rating of the work quality) from the output text of the last text generation model.

At step 144, a work quality score may be determined based on the text of step 143. In an example, a quality score may be between [0,1], with a higher score indicating better work quality. At step 145, the work quality (e.g., score and text description) may be communicated back to device 101 (e.g., technician's device) or device 102 (e.g., a supervisor). A machine learning model may be trained so that it can predict a desirable score based on the text input using a dataset of human labelled text descriptions. For example, in the training dataset, there may be a text description such as: “the wire is not properly buried into the ground”, and based on technician's experience, this indicates low quality, so its quality may be rated as 0. So, the machine learning model may learn that this type of description indicates 0 work quality, then it may predict the work quality score for a very similar/same description.

The work quality assessment module may use text mining and topic modeling to continuously track the work quality issues encountered by the technician, and notify the management team when a major work quality issue arises, so that actions may be taken to resolve/improve work quality. In an example, technicians may be coached (e.g., via a sent link to on demand multimedia or live instruction) to avoid this specific work quality issue, or to modify the method to mitigate work quality issues. The input to the work quality assessment module may be a photo of the technician's work scene. The output of the work quality assessment module may be a score or a text description.

The input to the work quality assessment module may be the text and quality score generated from a previous work quality assessment module. This may be used to track the work quality scores and if some anomaly (e.g., a large score decrease) happens, it can raise an alert.

The work quality score may be used to filter the text, such as only keep text descriptions whose quality score is less than 1 (which means the work is problematic). Then Latent Semantic Analysis (LSA) or Latent Dirichlet Allocation (LDA) may be used to perform topic modeling on the texts and extract major topics trends in the texts.

An effect of the disclosed system may include dramatically reducing human labor involved in visual inspection or evaluation of work quality. The system may reduce the evaluation time and increase the efficiency compared with conventional work quality assessment approaches. Although there are systems that may test the immediate functionality of a service (e.g., on or off), the disclosed system may assist in the quality of the install which may in turn help to reduce issues that may be avoided by utilizing proper installation techniques and avoiding repetitive manual assessment work.

The text generation model of work quality assessment module generates a text summarization of work quality issues of the image. The transformation from visual information to text information greatly facilitates users to search and retrieve information about a specific work quality issue

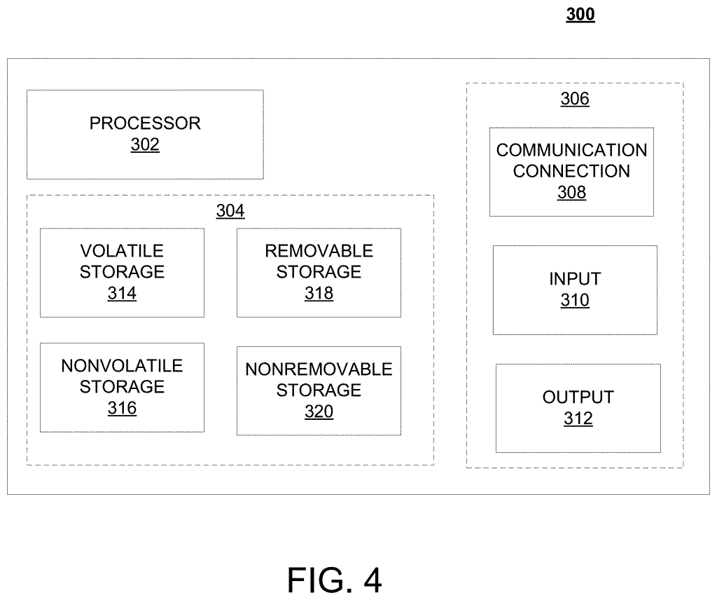

FIG. 4 is a block diagram of network device 300 that may be connected to or comprise a component of system 100 of FIG. 1. Network device 300 may comprise hardware or a combination of hardware and software. The functionality to facilitate telecommunications via a telecommunications network may reside in one or combination of network devices 300. Network device 300 depicted in FIG. 4 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 4 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 4) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

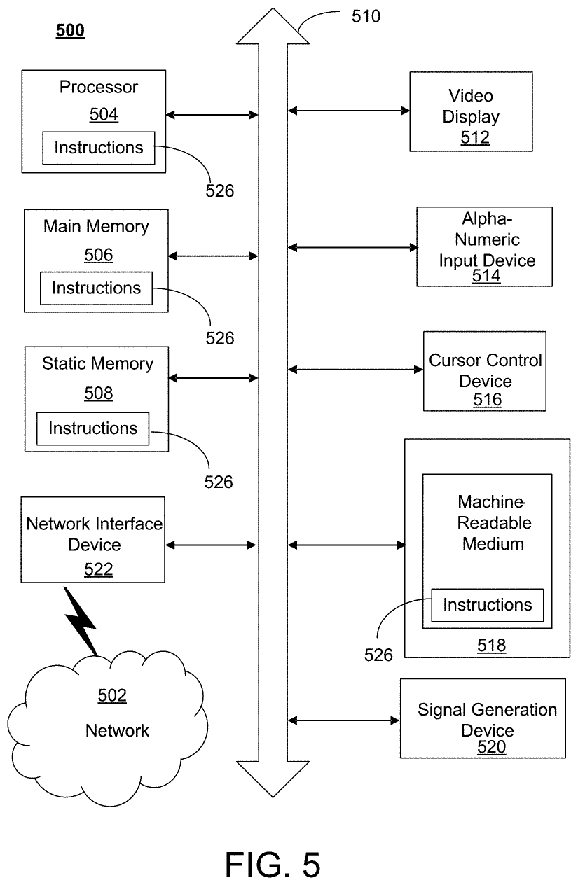

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 302, device 101, device 102, server 105, base station 111, base station 113, and other devices of FIG. 1. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which intelligent CV assisted installation alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—intelligent CV assisted installation—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for intelligent CV assisted installation. A method, system, computer readable storage medium, or apparatus provides for receiving an image; receiving an indication of a type of service installation associated with the image; determining objects of interest in the image associated with the type of service installation; determining whether the objects of interest in the image meet a minimum threshold for the type of service; and communicating acceptance or rejection of the image for a work quality assessment. The type of service installation may include a telecommunication service or electrical service. The image may be from a photo taken by a mobile device at a location. The type of service installation may include a utility service. The objects of interest may include a wire or a utility box. A method, system, computer readable storage medium, or apparatus provides for in response to acceptance of the image, extracting a feature map of the image; generating a text description of work quality based on the feature map; determining a work quality score based on the text description; or communicating the work quality score to a display of a device (e.g., mobile phone). All combinations in this paragraph (including the removal or addition of steps) are contemplated in a manner that is consistent with the other portions of the detailed description.

What is claimed:

1. A method comprising:
receiving an image;
receiving an indication of a type of service installation associated with the image;
determining objects of interest in the image associated with the type of service installation;
determining whether the objects of interest in the image meet a minimum threshold for the type of service; and
communicating acceptance or rejection of the image for a work quality assessment.

2. The method of claim 1, wherein the type of service installation comprises a telecommunication service or electrical service.

3. The method of claim 1, wherein the image is from a photo taken by a mobile device at a location.

4. The method of claim 1, wherein the type of service installation comprises a utility service.

5. The method of claim 1, wherein the objects of interest comprises a wire or a utility box.

6. The method of claim 1, further comprising in response to acceptance of the image, extracting a feature map of the image.

7. The method of claim 1, further comprising:
in response to acceptance of the image, extracting a feature map of the image; and
generating a text description of work quality based on the feature map.

8. The method of claim 1, further comprising:
in response to acceptance of the image, extracting a feature map of the image;
generating a text description of work quality based on the feature map; and
determining a work quality score based on the text description.

9. The method of claim 1, further comprising:
in response to acceptance of the image, extracting a feature map of the image;
generating a text description of work quality based on the feature map;
determining a work quality score based on the text description; and
communicating the work quality score to a display of a device.

10. A system comprising:
one or more processors; and
memory coupled with the one or more processors, the memory storing executable instructions that when executed by the one or more processors cause the one or more processors to effectuate operations comprising:
receiving an image;
receiving an indication of a type of service installation associated with the image;
determining objects of interest in the image associated with the type of service installation;
determining whether the objects of interest in the image meet a minimum threshold for the type of service; and
communicating acceptance or rejection of the image for a work quality assessment.

11. The system of claim 10, wherein the type of service installation comprises a telecommunication service or electrical service.

12. The system of claim 10, wherein the image is from a photo taken by a mobile device at a location.

13. The system of claim 10, wherein the type of service installation comprises a utility service.

14. The system of claim 10, wherein the objects of interest comprises a wire or a utility box.

15. The system of claim 10, the operations further comprising in response to acceptance of the image, extracting a feature map of the image.

16. The system of claim 10, the operations further comprising:
in response to acceptance of the image, extracting a feature map of the image; and
generating a text description of work quality based on the feature map.

17. The system of claim 10, the operations further comprising:
in response to acceptance of the image, extracting a feature map of the image;
generating a text description of work quality based on the feature map; and
determining a work quality score based on the text description.

18. The system of claim 10, the operations further comprising:
in response to acceptance of the image, extracting a feature map of the image;
generating a text description of work quality based on the feature map;
determining a work quality score based on the text description; and
communicating the work quality score to a display of a device.

19. A computer readable storage medium storing computer executable instructions that when executed by a computing device cause said computing device to effectuate operations comprising:
receiving an image;
receiving an indication of a type of service installation associated with the image;
determining objects of interest in the image associated with the type of service installation;
determining whether the objects of interest in the image meet a minimum threshold for the type of service; and
communicating acceptance or rejection of the image for a work quality assessment.

20. The computer readable storage medium of claim 19, wherein the type of service installation comprises a telecommunication service.
